(19) United States
(12) Patent Application Publication
(10) Pub. No.: US 2007/0171064 A1
(43) Pub. Date: Jul. 26, 2007

(54) Wristwatch security system

(76) Inventors: Charles Rollo, White Lake, MI (US); Robert Book, Auburn Hills, MI (US)

Correspondence Address: Douglas P. LaLone, Esq.;Rader, Fishman & Grauer, PLLC, Ste. 140, 39533 Woodward Ave., Bloomfield Hills, MI, 48304, US

(21) Appl. No.: 11/336,583

(22) Filed: Jan. 20, 2006

(51) Int. Cl. G08B 13/14

(52) U.S. Cl. 340/572.1

(57) ABSTRACT

Security systems such as those suitable for use with luxury items, such as wristwatches, are described. The systems primarily include: (1) a transmitter physically associated with the item, wherein the transmitter is operable to generate an electronic signal, wherein the electronic signal contains information regarding the status of the item; (2) a receiver operable to receive the electronic signal from the transmitter; and (3) a database containing information regarding the status of the item, wherein the information regarding the status of the object contained by the electronic signal is operable to be compared to the information regarding the status of the object contained by the database. The information can include ownership information, product identification information, manufacture information, purchase information, maintenance information, repair information, warranty information, and the like.

### FIELD OF THE INVENTION

The present invention generally relates to security systems, and more particularly to new and improved security systems for use in conjunction with monitoring the status of luxury items, such as but not limited to wristwatches.

### BACKGROUND AND SUMMARY OF THE INVENTION

Luxury wristwatches, such as those sold under the BREITLING®, OMEGA®, and ROLEX® brands, can cost several thousands of dollars, and thus, are potential targets for thieves who aim to steal them and attempt to sell them to unwary and/or unscrupulous consumers and/or wristwatch dealers. In an attempt to discourage the thievery of these items, as well as other luxury goods, various manufacturers and related businesses have been using, or encouraging the use of unobtrusive and/or inconspicuous devices that permit the identification and location of stolen items by several different methods.

Many of these devices employ wireless electronic means that allow communication between a transmitter (e.g. that is typically physically associated with the goods such as an embedded electronic chip) and a receiver that is typically operable to receive an electronic signal from the transmitter and is generally able to interpret and display information associated with that electronic signal. These types of devices are sometimes referred to as radio frequency identification devices (“RFID” or alternatively “RFID tags”). An example of one of these RFID tags is marketed under the trade name LUXE-ID™ and is readily commercially available from MSSS, S.A. (Corselles, Switzerland).

Conventional security systems that rely on RFID technology are limited in their utility and effectiveness in that the transmitter chips are sometimes limited in the data that can be stored therein as well as the difficulty and/or impossibility of changing and/or updating the data stored therein. Additionally, many of the receivers (e.g., scanners, interrogators, and the like) are generally handheld devices that are not in communication with other devices, such as a centralized computer database, that can store and further process the information, and, if necessary, further communicate with other devices, such as additional computers and/or databases. Furthermore, information technology is not being used optimally in conjunction with RFID technology to create information management systems that can effectively identify, track, and characterize these luxury items and communicate this information to various other parties.

Accordingly, there exists a need for new and improved security systems, especially those for use in conjunction with luxury items, such as but not limited to wristwatches.

In accordance with the general teachings of the present invention, new and improved security systems are provided. More specifically, the security systems of the present invention are intended to be used in conjunction with luxury items such as but not limited to wristwatches.

Transmitters, such as but not limited to GPB systems, transponders, and other devices such as RFID tags and the like are preferably physically associated with the items, e.g., by embedding them therein. The transmitters, which are preferably modifiable so as to be read/writeable, preferably contain information concerning the status of the item. This information can include, without limitation, ownership information, product identification information, manufacture information, purchase information, maintenance information, repair information, warranty information, and the like.

The transmitters are preferably operable to be read by receivers that are preferably operable to receive and/or interpret the electronic signal from the transmitter. The receivers are preferably mobile so as to be able to access the area that the transmitter is located. The receiver is preferably operable to display the information form the electronic signal in a visible and readable form such that an operator can understand the displayed information, e.g., in conjunction with a screen or monitor.

This information can then be compared to information about the item that is stored in one or more databases, including but not limited to computerized databases, networks, internets, intranets, ethernets, and the like. In this manner, the accuracy of the information stored on the transmitter can be corrected and/or updated. Alternatively, if the information stored in the databases in inaccurate, the information stored therein can be corrected and/or updated.

In accordance with a first embodiment of the present invention, a security system for an object is providing, comprising: (1) a transmitter physically associated with the object, wherein the transmitter is operable to generate an electronic signal, wherein the electronic signal contains information regarding the status of the object; (2) a receiver operable to receive the electronic signal from the transmitter; and (3) a database containing information regarding the status of the object, wherein the information regarding the status of the object contained by the electronic signal is operable to be compared to the information regarding the status of the object contained by the database.

In accordance with a second embodiment of the present invention, a security system for an object is provided, comprising: (1) a transmitter physically associated with the object, wherein the transmitter is operable to generate an electronic signal, wherein the electronic signal contains information regarding the status of the object, wherein the transmitter is operable to be modified to update the information regarding the status of the object; (2) a receiver operable to receive the electronic signal from the transmitter; and (3) a database containing information regarding the status of the object, wherein the information regarding the status of the object contained by the electronic signal is operable to be compared to the information regarding the status of the object contained by the database, wherein, the database is operable to be modified to update the information regarding the status of the object.

In accordance with a third embodiment of the present invention, a security system for an object is provided, comprising: (1) a transmitter physically associated with the object, wherein the transmitter is operable to generate an electronic signal, wherein the electronic signal contains information regarding the status of the object, wherein the transmitter is operable to be modified to update the information regarding the status of the object; (2) a receiver operable to receive the electronic signal from the transmitter; and (3) a database containing information regarding the status of the object, wherein the information regarding the status of the object contained by the electronic signal is operable to be compared to the information regarding the status of the object contained by the database, wherein the database is operable to be modified to update the information regarding the status of the object, wherein the information is selected from the group consisting of ownership information, product identification information, manufacture information, purchase information, maintenance information, repair information, warranty information, and combinations thereof.

A further understanding of the present invention will be had in view of the description of the drawings and detailed description of the invention, when viewed in conjunction with the subjoined claims.

### BRIEF DESCRIPTION OF THE DRAWINGS

The present invention will become more fully understood from the detailed description and the accompanying drawings, wherein:

FIG. 1 illustrates a flow chart illustrating the primary processing steps of a security system for an object, in accordance with one embodiment of the present invention;

FIG. 2 illustrates a flow chart illustrating the primary processing steps of a security system for an object, in accordance with a second embodiment of the present invention; and

FIG. 3 illustrates a flow chart illustrating the primary processing steps of a security system for an object, in accordance with a third embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

In accordance with the general teachings of the present invention, a security system is provided that can be used to provide a status tracking function, among other functions, in conjunction with an object.

In accordance with a preferred embodiment of the present invention, the object is a luxury item. The phrase “luxury item,” as that term is used herein, is generally defined as an item of significant monetary, artistic, aesthetic, historical, security, and/or sentimental value. Non-limiting examples of luxury items include wristwatches, timepieces, clocks, jewelry, painting, sculptures, books, fine furniture, communications equipment, computers, electronics, and the like.

The term “status” as that term is used herein, is generally defined as information concerning ownership information, product identification information, manufacture information, purchase information, maintenance information, repair information, warranty information, and the like with respect to the object.

The security system of the present invention can either be installed at the time of manufacture and/or assembly by the original manufacturer, or alternatively, can be installed as an aftermarket item, e.g., by a service provider, such as but not limited to an authorized dealer, reseller, repair facility, and the like.

Although the security system can be installed on the exterior surface of the object, because of security and aesthetic reasons, the security system is preferably operable to be embedded within or otherwise physically associated with an interior surface and/or area of the object. By the way of a non-limiting example, the transmitter can be physically associated (e.g., mounted) within an internal surface of the rear plate of a wristwatch, embedded within the frame of a painting, embedded within the batting of an antique piece of furniture, and so forth.

The security system of the present invention preferably includes a transmitter physically associated with the object. By the term “transmitter,” as that term is used herein, it is meant to include any data recording and/or data transmitting system, and can include, without limitation RFIDs, chips, compact discs, and any other type of media that can either record and/or transmit data. The transmitter can be either passive (e.g., it odes not transmit data independently and/or spontaneously) and/or active (e.g., it does transmit data independently and/or spontaneously). By way of a no-limiting example, the security system of the present invention can preferably employ an RFID chip embedded within the object that is operable to generate an electronic signal, e.g. when interrogated by a receiver.

In accordance with a preferred embodiment of the present invention, the transmitter is preferably readable, in that the data can be accessed, still more preferably it is writeable, in that data can be written to the transmitter, e.g., for correction and/or updating purposes, and most preferably it is both readable and writeable.

The security system of the present invention preferably also includes a receiver that is operable to access the data contained on the transmitter. By the term “receiver,” as that term is used herein, it is meant to include any data capture, reading, imaging, and/or interpretation system, and can include, without limitation, readers, interrogators, scanners, any other type of device that can capture, read, image, and/or interpret data contained on the transmitter.

The receiver is preferably operable to access the information contained on the transmitter without harming the object or causing the object to be dismantled to any substantial degree. In accordance with a preferred embodiment of the present invention, the receiver preferably uses non-destructive technology to access the information contained on the transmitter, such as but not limited to various frequencies of laser beams, radio waves, infrared waves, ultraviolet waves, and the like. Furthermore, the receiver is preferably operable to access the information contained on the transmitter even if material is disposed between the receiver and the transmitter. For example, the receiver should be operable to retrieve the data contained on the transmitter even if the transmitter is contained within or embedded within an interior area of the object.

As previously noted, the information contained on the transmitter preferably relates to status of the object. This information can include, without limitation, information concerning ownership information, product identification information, manufacture information, purchase information, maintenance information, repair information, warranty information, and the like, with respect to the object.

Ownership information can include, without limitation, information including the name, address, telephone number, and other pertinent information pertaining to the current owner, as well as any previous owners of the object.

Product identification information can include, without limitation, information including the product model number, serial number, and other pertinent information pertaining to the object.

Manufacture information can include, without limitation, information including the manufacturer's name, address and telephone number, place of manufacture, date of manufacture, and other pertinent information pertaining to the object.

Purchase information can include, without limitation, information including the seller's name, address and telephone number, the purchase price, and other pertinent information pertaining to the last seller, as well as any previous sellers of the object.

Maintenance information can include, without limitation, information including the required and/or suggested maintenance schedule, a log of previous maintenance operations performed, the result of those maintenance operations, and other pertinent information pertaining to the object.

Repair information can include, without limitation, information including the date, place, cost, description, and results of any repairs performed on the object, and other pertinent information pertaining to the object.

Warranty information can include, without limitation, information including the terms of the warranty, whether the warranty is still in effect, the date that the warranty expires, whether an extended warranty is available, whether the warranty has been breached, and what actions caused the warranty to be breached, and other pertinent information pertaining to the object.

Many other types of additional information can also be stored on the transmitter, depending on the particular requirements of the manufacturer, reseller, repair facility and/or consumer. This information can include without limitation, appraised value, insurance information, reward information if the object is stolen or lost, and the like. Additionally, a coded system may be employed if secrecy concerning the particulars of the object is warranted, e.g., such as would be required with sensitive government—and/or military—related objects.

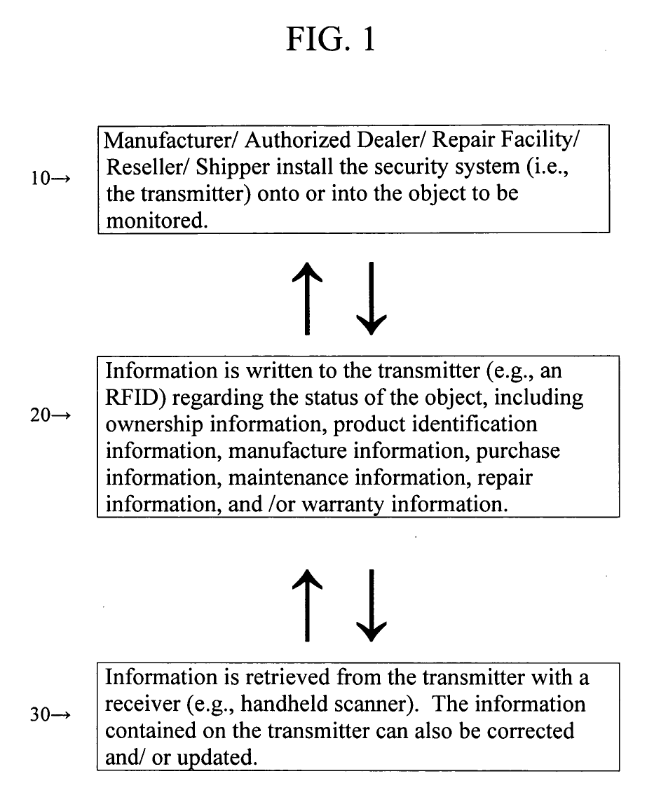

In accordance with a non-limiting example, the primary processing steps of such a security system, as previously described, are depicted in FIG. 1. In this view, the manufacturer, authorized dealer, repair facility, or reseller can accomplish the installation step 10. The installation of the transmitter can either be on an external, or more preferably, an internal surface of the object. The requisite information can then be written to the transmitter during the data loading step 20. Alternatively, the data can also be written to the transmitter before actual installation occurs. The data can comprise information such as, but not limited to ownership information, product identification information, manufacture information, purchase information, maintenance information, repair information, warranty information, and the like. Finally, the data can be retrieved from the transmitter by employing a receiver (e.g., an interrogator, scanner or the like) during the data retrieval step 30. Alternatively, the data can also be retrieved from the transmitter before actual installation occurs so as to ensure that the transmitter is functioning properly.

In accordance with a preferred embodiment of the present invention, at least some, and more preferably all of the aforementioned types of information is preferably stored in a centralized repository, such as but not limited to a computer database. By way of a non-limiting example, if the manufacturer installs the device, the manufacturer, or its designee, preferably compiles and/or administers the database. By way of another non-limiting example, if the device is installed as an aftermarket item, for example, by an authorized dealer, reseller, and/or repair facility or the like, then one of those entities, or its designees, preferably compiles and/or administers the database. Alternatively, the manufacturer could retain control over the database function, regardless of whether the security system was installed prior to or after manufacture. Furthermore, some or all of the database function could be outsourced to a security service that has no direct involvement in the manufacture, sale, and/or service of the object.

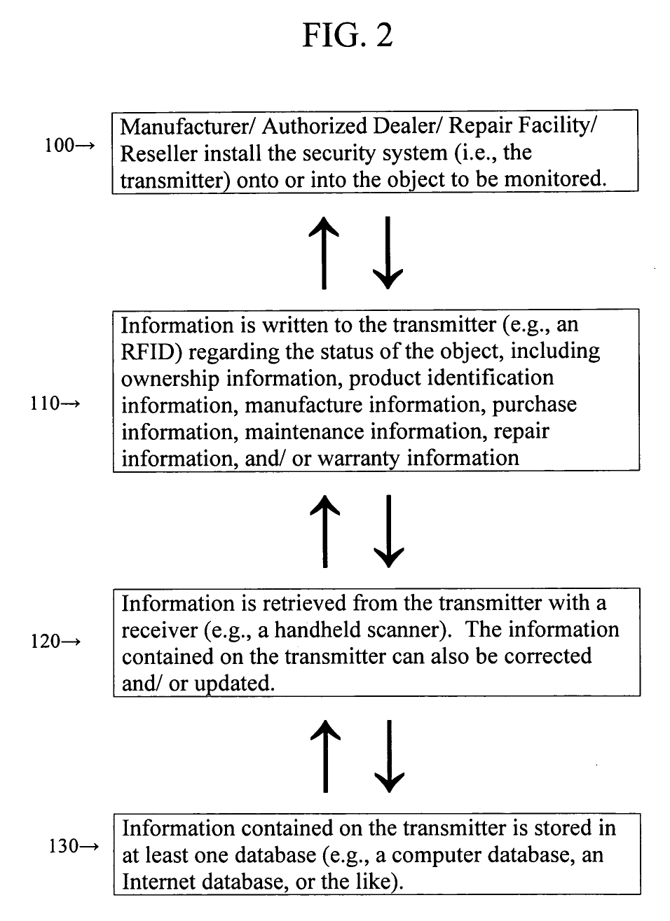

In accordance with a non-limiting example, the primary processing steps of such a security system, as previously described, are depicted in FIG. 2. As with the embodiment described in FIG. 1, there is provided an installation step 100, a data loading step 110, a data retrieval step 120, as previously described. However, this embodiment differs in that there is provided a database storage step 130, wherein data from the transmitter, or alternatively, data retrieved by the receiver, is stored on at least one database.

Regardless of who creates and/or administers the database, the database provides a convenient source of information from which to compare to information contained on the transmitter, to determine its correctness and/or accuracy. Further, the presence of a database allows entities and individuals the opportunity to access that database, or portions thereof, in order to obtain information about the object. By way of a non-limiting example, an entity or individual could telephone the database administrator to acquire information about the object or update the information contained in the database (e.g., change of owner's address). Alternatively, the transmitter and/or receiver could be operable to directly or indirectly communicate with the database to either determine the correctness and/or accuracy of the information, or alternatively, could update the information contained on the database.

In accordance with another preferred embodiment of the present invention, at least some, and more preferably all, of the aforementioned types of information is preferably stored in another centralized repository, such as but not limited to an Internet-based database, which because of the nature of the information contained thereon, would be properly protected, e.g., through passwords, encryption, and the like. Thus, by way of a non-limiting example, an authorized entity or individual could log onto the website containing the database and retrieve information therefrom, or alternatively, update information (e.g., change of owner's address) contained thereon.

In accordance with still another preferred embodiment of the present invention, at least some, and more preferably all of the aforementioned types of information is preferably stored ins till another centralized repository, such as but not limited to an insurance company administered database. By way of a non-limiting example, the insured of the insurance company could submit their information directly to the insurance company, or the security system administrator (e.g., the manufacturer) could provide the required information to the insurance company on behalf of the insured. Thus, by way of a non-limiting example, if a claim is filed when the object is either stolen or lost, the settlement process could be shortened in duration.

In accordance with still yet another preferred embodiment of the present invention, at least some, and more preferably all of the aforementioned types of information is preferably stored in still yet another centralized repository, such as but not limited to a governmental—and/or law enforcement—administered database. By way of a non-limiting example, because some of these objects can be historic (e.g., national archives) or sensitive (e.g. military computers) in nature, readily tracking their status is of particular importance. Furthermore, having this information stored in a law enforcement—administered database could aid in the quick resolution of crime investigations and the return of stolen objects to their lawful owners.

In accordance with a preferred embodiment, the transmitter, receiver, and/or the aforementioned databases are preferably linked and/or in communication with one another so as to provide authorized access thereto so as to facilitate the rapid transfer and/or dissemination of information about the object.

In accordance with a highly preferred embodiment of the present invention, the transmitter can be configured so as to contain an unsecured portion, wherein data can be relatively freely accessed and/or written to the transmitter, as well as a secured portion, wherein data can be accessed and/or written only by authorized parties, such as but not limited to the manufacturer, authorized dealers, and the like. The reason for this is that some of the information contained on the transmitter is potentially private (e.g., current owner's address) and/or sensitive (e.g., classified information), so the ability to restrict access to these portions of the transmitter is highly preferred.

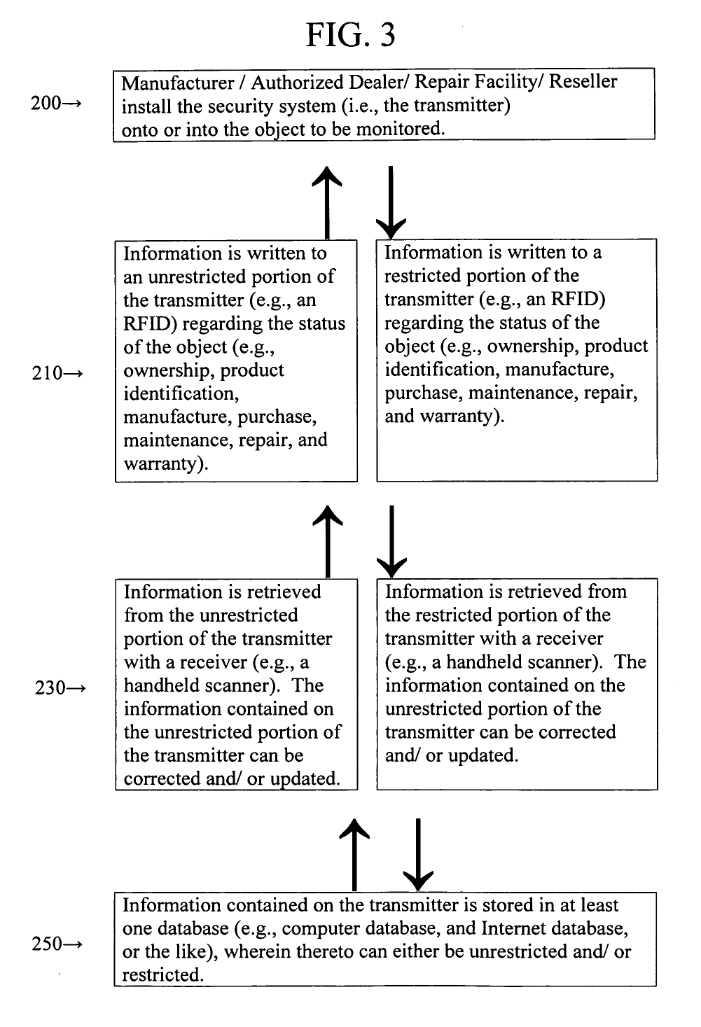

In accordance with a non-limiting example, the primary processing steps of such a security system, as previously described, are depicted in FIG. 3. As with the embodiment described in FIGS. 1 and 2, there is provided an installation step 200, as previously described. However, this embodiment differs in that there is provided a data loading step that can be divided in unrestricted and restricted data upload portions, 210, 220, respectively, of the transmitter. That is, certain information can be loaded to an unrestricted portion of the transmitter, which can be viewed with any type of receiver, whereas certain other information, e.g., of a sensitive nature, can be loaded to a restricted portion of the transmitter, which can only be viewed by authorized entities and/or individuals (e.g., law enforcement, military and the like). Further this embodiment differs in that the information retrieval step can be divided into unrestricted and restricted portions, 230, 240, respectively, of the transmitter, or alternatively, of the receiver. As previously noted, unrestricted data can be freely viewed, whereas restricted data can only be viewed under certain controlled conditions. Finally, as with the embodiment depicted in FIG. 2, there is provided a database storage step 250, wherein data from the transmitter, or alternatively, data retrieved by the receiver, is stored on at least one database. However, the data can be segregated into unrestricted (e.g. for viewing of non-sensitive information by potential buyers of the objects) and restricted databases (e.g., for viewing of sensitive information by current owners of the objects).

Those skilled in the art can now appreciate from the foregoing description that the broad teachings of the present invention can be implemented in a variety of forms. Therefore, while this invention has been described in connection with particular examples thereof, the true scope of the invention should not be so limited, since other modifications will become apparent to the skilled practitioner upon a study of the drawings, specification and following claims.

What is claimed is:

1. A security system for an object, comprising:
a transmitter physically associated with the object, wherein the transmitter is operable to generate an electronic signal, wherein the electronic signal contains information regarding the status of the object;
a receiver operable to receive the electronic signal from the transmitter; and
a database containing information regarding the status of the object, wherein the information regarding the status of the object contained by the electronic signal is operable to be compared to the information regarding the status of the object contained by the database.

2. The invention according to claim 1, wherein the object is a luxury item.

3. The invention according to claim 1, wherein the object is a wristwatch.

4. The invention according to claim 1, wherein the transmitter is a radio frequency identification device.

5. The invention according to claim 1, wherein the transmitter is operable to be modified to update the information regarding the status of the object.

6. The invention according to claim 1, wherein the transmitter is either readable, writeable, or both.

7. The invention according to claim 1, wherein the database is operable to be modified to update the information regarding the status of the object.

8. The invention according to claim 1, further comprising a second database containing information regarding the status of the object.

9. The invention according to claim 1, wherein the information is selected from the group consisting of ownership information, product identification information, manufacture information, purchase information, maintenance information, repair information, warranty information, and combinations thereof.

10. A security system for an object comprising:
a transmitter physically associated with the object, wherein the transmitter is operable to generate an electronic signal, wherein the electronic signal contains information regarding the status of the object, wherein the transmitter is operable to be modified to update the information regarding the status of the object;
a receiver operable to receive the electronic signal from the transmitter; and
a database containing information regarding the status of the object, wherein the information regarding the status of the object contained by the electronic signal is operable to be compared to the information regarding the status of the object contained by the database, wherein the database is operable to be modified to update the information regarding the status of the object.

11. The invention according to claim 10, wherein the object is a luxury item.

12. The invention according to claim 10, wherein the object is a wristwatch.

13. The invention according to claim 10, wherein the transmitter is a radio frequency identification device.

14. The invention according to claim 10, wherein the transmitter is either readable, writeable, or both.

15. The invention according to claim 10, wherein the information is selected from the group consisting of ownership information, product identification information, manufacture information, purchase information, maintenance information, repair information, warranty information, and combinations thereof.

16. A security system for an object, comprising:
a transmitter physically associated with the object, wherein the transmitter is operable to generate an electronic signal, wherein the electronic signal contains information regarding the status of the object, wherein the transmitter is operable to be modified to update the information regarding the status of the object;
a receiver operable to receive the electronic signal from the transmitter; and
a database containing information regarding the status of the object, wherein the information regarding the status of the object contained by the electronic signal is operable to be compared to the information regarding the status of the object contained by the database, wherein the database is operable to be modified to update the information regarding the status of the object;
wherein the information is selected from the group consisting of ownership information, product identification information, manufacture information, purchase information, maintenance information, repair information, warranty information, and combinations thereof.

17. The invention according to claim 16, wherein the object is a luxury item.

18. The invention according to claim 16, wherein the object is a wristwatch.

19. The invention according to claim 15, wherein the transmitter is a radio frequency identification device.

20. The invention according to claim 15, wherein the transmitter is either readable, writeable, or both.
